(19) United States
(12) Patent Application Publication
(10) Pub. No.: US 2016/0159546 A1
(43) Pub. Date: Jun. 9, 2016

(54) Container Inner Seal With A Releasable Panel

(71) Applicant: SELIG SEALING PRODUCTS, INC., Forrest, IL (US)

(72) Inventors: Stephen P. Cassidy, South Barrington, IL (US); John J. Brown, LaGrange, IL (US); Heinz H. Wiening, Niederglatt (CH)

(21) Appl. No.: 14/905,146

(22) PCT Filed: Jul. 15, 2014
(86) PCT No.: PCT/US2014/046594

§ 371 Date: Jan. 14, 2016

(30) Foreign Application Priority Data
Jul. 16, 2013 (CH) 01268/13

(51) Int. Cl. B65D 77/20; B26D 3/08; B26D 1/62; B65D 53/08

(52) U.S. Cl. CPC B65D 77/2056; B65D 53/08; B26D 3/085; B26D 1/626; B65D 2577/2091

(57) ABSTRACT

A sealing member for a container and/or film including at least one frangible line of weakness. In some approaches, the sealing member with the frangible line of weakness is configured to release a panel or strip to expose portions of the sealing member therebelow for ease in gaining access to the container contents.

### CROSS-REFERENCE TO RELATED APPLICATIONS

This application claims benefit of Switzerland Patent Application No. 01268/13, filed Jul. 16, 2013, which is hereby incorporated herein by reference in its entirety

### FIELD

This disclosure relates to container sealing members, and more particularly to container sealing members having a releasable, and, in some cases, a removable portion.

### BACKGROUND

It is common to seal a bottle, jar, or other container with a screw cap and a sealing member, often called a seal liner or inner seal, across the mouth of the container. Typically, this sealing member can provide protection, evidence of tampering, a vapor barrier or, in some cases, a hermetic seal. In some instances, these sealing members can be provided in a two-piece sealing member configuration with the sealing member combined with an upper cap liner portion.

The sealing member is commonly a laminate of layers that often includes at least a heat sensitive sealing layer or bonding layer covered by a metal foil layer. The heat sensitive layer is a lower layer within the laminate and adheres the sealing member to the rim or mouth of a container. In a two-piece configuration, the sealing member is temporarily bonded to the upper cap liner. In this configuration, the upper cap liner often includes a compressing agent (e.g., pulp board, synthetic foam, or the like) that is adjacent the interior of the screw cap and positioned at the opposite end of the sealing member from the heat sensitive sealing layer. There is usually a release layer, such as wax, in the two-piece configurations between the upper cap liner and the lower sealing member. The release layer is effective to initially hold the upper cap liner to the lower sealing member to form a unitary or one-piece structure to aid in assembling the cap and container, but then the release layer permits the sealing member to separate between these two portions upon cap removal.

In use, the sealing member is inserted into a container or bottle cap at a closure manufacturer. The cap and sealing member combination may then be provided to an end user that places the cap onto a container mouth where the sealing member is induction or otherwise heat sealed to the upper rim of a bottle or container. During induction sealing, an electromagnetic field generated by induction heating equipment produces heat in the metal foil layer of the sealing member to activate the heat sensitive sealing layer for bonding to the rim or mouth of a container. At the same time, if the sealing member is a two-piece configuration, the heating may also cause the release layer to separate the upper cap liner from the lower sealing member. In the case of a two-piece assembly using a wax layer, the induction heating causes the wax to melt and be absorbed by the compressing agent in the upper cap liner. This converts the one-piece sealing member into two pieces, with the sealing member and its heat sensitive sealing layer bonding to the container rim, and with the melted wax being absorbed by the compressing agent in the upper cap liner, the liner separates and stays in the cap. The compressing agent generally remains lodged in the inner portion of the cap as a cap liner, and the sealing member remains adhered to the container when the cap is removed from the bottle by the consumer.

When the cap is removed, the consumer, depending on the application, then removes, tears, penetrates, or breaks the sealing member from the container rim before the contents of the container may be accessed. The cap may then be screwed back onto the container if desired. Upon initial removal of the cap, a missing or damaged sealing member can alert the consumer that the contents of the container may have been tampered with prior to purchase.

Many applications, however, call for a laminate structure forming the sealing member to remain on the container, but not be readily pierced unless a tool, such as a knife or other relatively sharp object, pierces the sealing member. In such cases, it is common for the laminate forming the sealing member to include one or more layers of a relatively strong polymer film, such as polyethylene terephthalate (PET) or nylon, to impart resistance to puncturing and tearing. In many cases, the top layer of the laminate forming the sealing member is PET. However, there is a shortcoming in such designs because the PET layers are difficult to pierce without a tool, and the consumer typically will not be able to pierce such laminates with just their finger. Thus, if consumers don't have ready access to a sharp object, they can be frustrated upon trying to pierce the sealing member with their finger or other blunt object.

### BRIEF DESCRIPTION OF THE DRAWINGS

FIG. 1 is a perspective view of an exemplary sealing member with a portion configured to be released from the sealing member;

FIG. 2 is a perspective view of the exemplary sealing member of FIG. 1 showing the releasable portion;

FIGS. 3 and 4 are partially exploded cross-sectional views of exemplary sealing members;

FIG. 5 is a partially exploded cross-sectional view of a laminate sheet for forming sealing members herein;

FIGS. 6 and 7 are cross-sectional views of exemplary sealing members;

FIGS. 8A, 8B, and 8C are perspective views of exemplary sealing members;

FIG. 9 is a perspective view of an alternative, exemplary sealing member with a portion configured to be released from the sealing member;

FIG. 10 is a perspective view of the exemplary sealing member of FIG. 9 showing the releasable portion;

FIGS. 11 and 12 are cross-sectional view of exemplary sealing members;

FIGS. 13A and 13B are perspective views of exemplary sealing members;

FIG. 14 is a cross-sectional view of an exemplary sealing member adhered to a container rim;

FIG. 15 is a perspective view of an exemplary sealing member;

FIG. 16 is a cross-sectional view of an alternative, exemplary sealing member;

FIG. 17 is a perspective view of a sealing member;

FIG. 18 is a cross-sectional view of an exemplary sealing member;

FIG. 19 is a perspective view of an article being packed by means of a film in an airtight manner;

FIG. 20 is a perspective of view of FIG. 1, wherein the package is being fractured;

FIG. 21 is a perspective view of a packed article having a fracturing seam applied to the package;

FIG. 22 is a cross sectional view of an exemplary fracturing seam of the package according to FIG. 21;

FIG. 23 is a perspective view of an exemplary arrangement of a pair of rolls for forming a fracturing seam;

FIG. 24 is a cross sectional view of an exemplary arrangement of rolls as shown in FIG. 23;

FIG. 25 is a perspective view of an approach using a pair of rolls arranged with two ribs circumferentially extending around the roll surface;

FIG. 26 is a perspective view of another approach using a pair of rolls including a plurality of longitudinally spaced ribs on a roll;

FIG. 27 is a perspective view of a further approach using a pair of rolls with ribs on both rolls in the pair;

FIG. 28 is a perspective, partial view of an exemplary rib having a corrugated outer profile; and

FIG. 29 is a perspective view of an arrangement including a plurality of pairs of rolls having ribs as well as additional, separate transport rolls.

### DETAILED DESCRIPTION

This disclosure relates to fracturing film and to laminate sealing members or inner seals that are heat sealed or adhered to the rim surrounding the opening of a container. In one aspect, the laminate sealing members herein include at least one fracturing seam or frangible line of weakness that is configured to be fractured, torn, or broken so that a portion or panel of the sealing member can be released from other portions of the sealing member. In some approaches, the sealing members may include more than one frangible line of weakness so that upon tearing, a panel or portion of material between the lines of weakness can be released and removed from the sealing member. These configurations permit a consumer to tear the one or more frangible lines of weakness to release and, optionally, remove a portion of the seal in order to expose and allow access to the laminate structure below and/or the contents of the container depending on the structure of the laminate. In some cases, the structures herein permit release and, optionally, removal of a laminate panel to expose a more easily piercable or puncturable portion of the sealing member so that the sealing member provides puncture resistance in its undisturbed form and, upon panel release, provides a sealing member with at least a portion that a consumer can easily puncture without a sharp object.

In other aspects, the sealing member structures herein permit initial configurations to include strong full layers of material, such as PET and Nylon, that impart resistance to piercing and puncturing so as to provide an enhanced level of protection during manufacturing, initial handling, and distribution. Upon subsequent consumer tearing of the frangible lines of weakness, the sealing members herein may then expose other layers therebelow that can be more readily breached or pierced without requiring the use of a piercing tool or other sharp implement. For instance, the initial seal with the full, puncture resistance layers may not be piercable by a user's finger or a common drinking straw, but upon tearing the one or more frangible lines of weakness and subsequent panel release, the released panel could expose sealing member layers (such as polyolefin, foils, and the like materials) that are more easily punctured by a finger and/or a common drinking straw.

The general descriptions of sealing members noted above may be tabbed or non-tabbed versions of sealing members. If tabbed, the sealing members may include peripheral side extending tabs that are associated with the frangible lines of weakness to help aid in tearing therealong. The sealing members may also include top-mounted tabs; such as, tabs that are defined wholly within the perimeter of the sealing member. In the case of a sealing member including a single frangible line of weakness, upon tearing by a consumer, a panel can be released and pivoted upwardly to form a single, top-mounted pull-tab defined wholly within a perimeter of the sealing member. A consumer can then use this formed pull tab to remove the sealing member from a container.

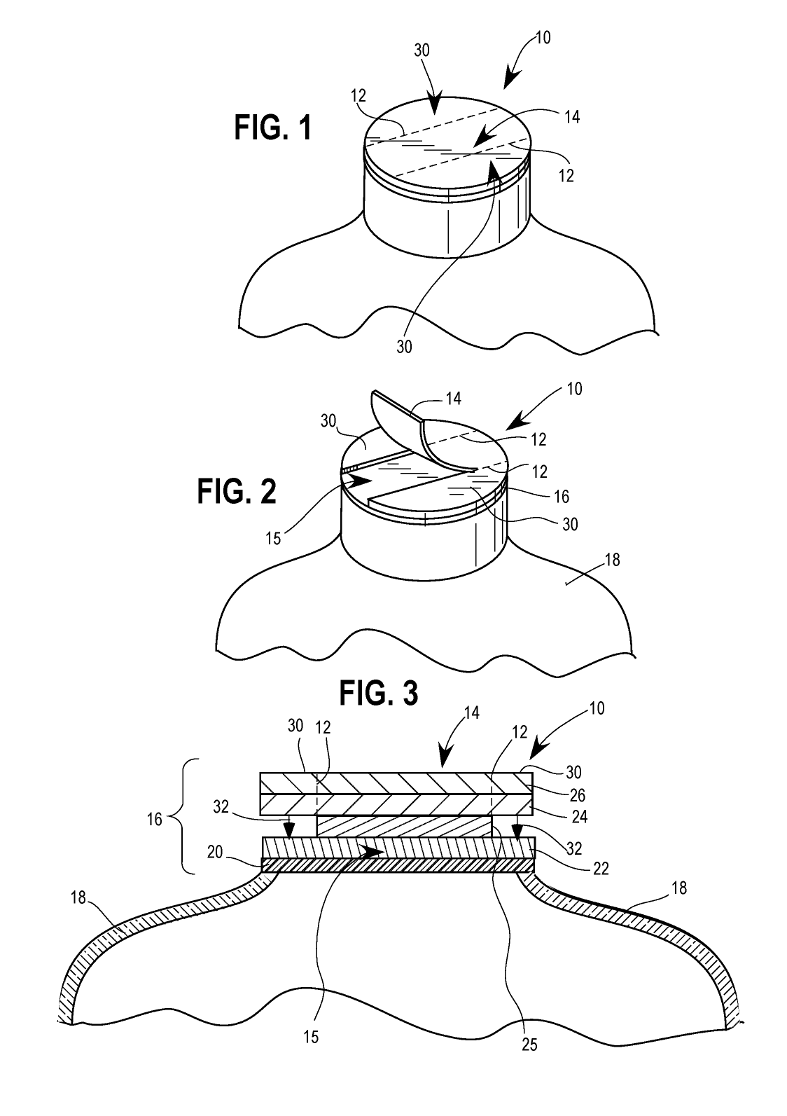

With the above background and summary in mind, different approaches to the sealing members with the one or more fracturing seam or frangible line of weakness herein will first be described, and then more specifics of the various constructions and materials will be explained thereafter. In this disclosure, use of the terms “upper” and “lower” with respect to surfaces of the sealing member components is in reference to an orientation of the components as generally depicted in FIGS. 1 to 18 and when the sealing member is in use with a container in an upright position and having an opening at the top of the container.

The sealing members herein may include a one-piece or two-piece sealing member provided as a laminate formed from flexible sheet materials that include a seal laminate with one or more frangible lines of weakness for permitting release of and the optional removal of a panel or portion of the sealing member. The sealing members may include various types of gripping tabs, which in some approaches, are aligned with one or more of the frangible lines of weakness to aid in tearing therealong or the sealing members may be free of any tabs. At least in certain approaches, the sealing members herein may include within the laminate a lower heat sealable layer for bonding to the rim of a container. Above or on top of the heat sealable layer may be a membrane or metal layer. The membrane or metal layer may be foil, aluminum, tin, metalized polymers, the like, as well as combinations thereof. The heat sealable layer may include a hot melt adhesive for bonding or securing the seal to the container rim by a heat seal or induction sealing apparatus, which heats the membrane layer and melts the heat sealable layer to bond the seal to the rim of the container.

In one approach and as generally shown in the FIGS. 1-8, a sealing member 10 is provided with a pair of spaced frangible lines of weakness 12 defining a releasable and removable panel or portion 14 (a so-called tear strip) between the pair of lines 12. The panel 14 can be peeled from the sealing member 10 by tearing along the frangible lines of weakness 12 to expose a more readily pierceable or puncturable portion 15 of the sealing member 10 under the panel 14.

So configured, a consumer can tear off the strip of material (i.e., the panels 14) as generally shown in FIGS. 2, 6, and 7 to allow access to thinner or more easily breachable underlying laminate layers 15 so that the portion 15 can be more easily pierced or punctured. For instance, the exposed portion 15 is constructed of layers can be easily pierced with a straw, such as generally shown in the cross-sectional view of FIG. 7. The exposed portion 15 can also be pierced with a finger to create one or more orifices to allow pouring or distribution of the container contents in a more controlled manner because the finger punched holes affords a smaller pouring orifice as compared to the removal of the entire seal.

In other approaches, the panel 14 could be part of a hologram or other visual anti-counterfeiting element that extends across the entire top layer of the seal 10. Upon peeling of the panel 14 by a consumer, the hologram is destroyed. There can also be printing on the underside of the panel 14 or on the exposed panel surface 15, which could be part of a game, branding, couponing, or further anti-counterfeiting elements. Removal of the panel 14 also creates an area (such as exposed portion 15) of the still sealed container with significantly different physical properties as compared to the remaining, opposing side portions 30 of the sealing member (see, e.g. FIG. 2). For instance, the side portions 30 will include all laminate layers, but the exposed portion 15 will only include a few of the laminate layers.

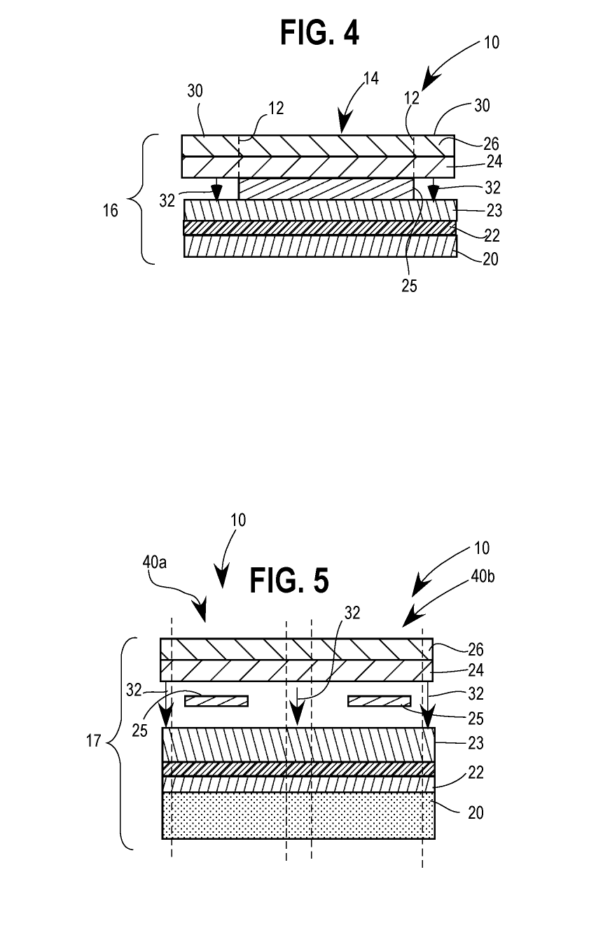

As shown in the cross-sectional view of FIGS. 3 and 4, the seal 10 may include a seal laminate 16 that can be bonded to a rim of a container 18. The seal laminate 16 may be a laminate or multi-layer sheet including, by one approach, a lower heat sealable layer 20, a membrane or induction heating layer 22, a bonding layer 24, and a top puncture resistance layer 26 as shown in FIG. 3. The lower heat sealable layer 20 is effective to secure the seal member 10 to a container rim during an induction sealing or other heat sealing process. The membrane layer 22 may be, as discussed, a metal layer such as foil, aluminum, tin, metalized polymers or any other layer capable of being heated by induction methods.

To permit the tear strip or panel 14 to be removable upon tearing along the frangible lines of weakness 12, the seal 10 may also include a partial release layer 25 that is a narrow strip of material that does not extend the full width of the seal, but generally corresponds to the tear strip 14 between the two frangible lines of weakness 12. The release layer 25 is bonded to the top layer 26 via the bonding layer 24, but it is not bonded to the layers below it and, thus, not bonded to portion 15 or layer 22 (or other layer above layer 22 if included). As shown in FIGS. 3 and 4, which are partially exploded, the bonding layer 24 is bonded to the layers below it in the opposing side portions 30 of the seal as indicated by bonding arrows 32.

The partial release layer 25 helps form two partial bonds on opposite sides thereof forming the opposing portions 30 because layer 25 is bonded to the top layer 26 (or other layers) and is adjacent to, but not bonded to, the layers below it. In this approach, partial release layer 25 helps form the tear strip 14 because it prevents the top layer 26 and bonding layer 24 from adhering to the layers below it across at least a portion 15 of the seal as generally shown in FIGS. 2, 6, and 7. In one aspect, the release layer is formed of polyester, such as polyethylene terephthalate (PET), or paper. By one optional approach, a lower surface of the release layer 25 may be coated with a release material, for example silicone. The optional release coating minimizes the possibility that the release layer 25 will become adhered to layers below it during the induction heat sealing process. However, such release coatings are not typically necessary.

FIG. 4 is an alternative construction of the laminate 16. This approach includes an additional layer 23 on top of the membrane layer 22. This additional layer 23 may be a polymer insulation layer (such as a foamed polymer), a heat distributing polymer layer, or a micro-perforated polymer film (such as the micro-perforated film described in provisional patent application U.S. Ser. No. 61/858,900, which is incorporated herein by reference). The additional layer 23 is, in some approaches, of a construction that renders it easily piercable or puncturable relative to the top layer 26.

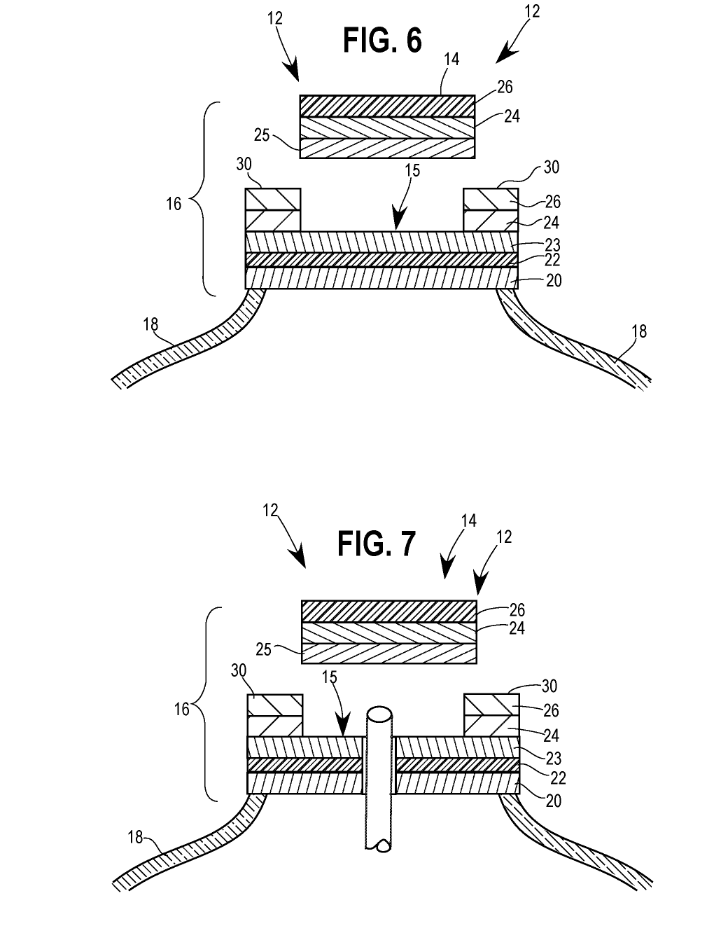

FIGS. 6 and 7 generally illustrate cross-sectional views of the tear strip 14 after being torn along the frangible lines of weakness 12 to release and remove the panel 14 from the sealing members of FIGS. 3 and 4, respectively. As shown, the top layer 26 and bonding layer 24 tear along the frangible lines of weakness so that the panel 14 can be removed from the seal 10 in view of the release layer 25 not being bonded to the layers beneath it. After panel 14 removal, the exposed portion 15 may be pierced or punctured as needed. For instance, FIG. 7 shows an exemplary straw or other implement piercing the foil 22 and heat seal layer 20 in the exposed portion 15. The exposed portion 15 in FIG. 6 could be pierced in a similar manner. As generally shown in these cross-sectional figures, the opposite edges of the release strip 25 are generally along or adjacent to the frangible lines of weakness 12, which extend through the top puncture resistant layer 26 and the bonding layer 24 (as well as any other layers as needed for a particular application). This close association between the edges of the release strip 25 and the frangible lines of weakness 12 permit a clean tear and separation of the panels 14. These figures include optional layer 23 as part of the laminate. It is appreciated that such layer is not needed in the structure.

Turning back to FIG. 5 for a moment, one example of how seals 10 may be formed via die punching a laminate sheet 17 of material is illustrated. In this approach, a wide laminate sheet 17 that includes the desired layers (such as those previously described) along with spaced strips of release material 25 across the sheet. The sheet may be heat laminated or extrusion assembled as needed for a particular application. Once laminated together (in FIG. 5, the layers are exploded for ease in viewing, again recall that layer 25 is not bonded to the layers below it), sealing members 10 can be die cut or die punched out of the sheet as generally shown by the exemplary die cuts 40a and 40b. While only two exemplary die cuts are illustrated, it will be appreciated that any number of die cuts may be made depending on the configuration or nesting of the die and size of the sheet 17.

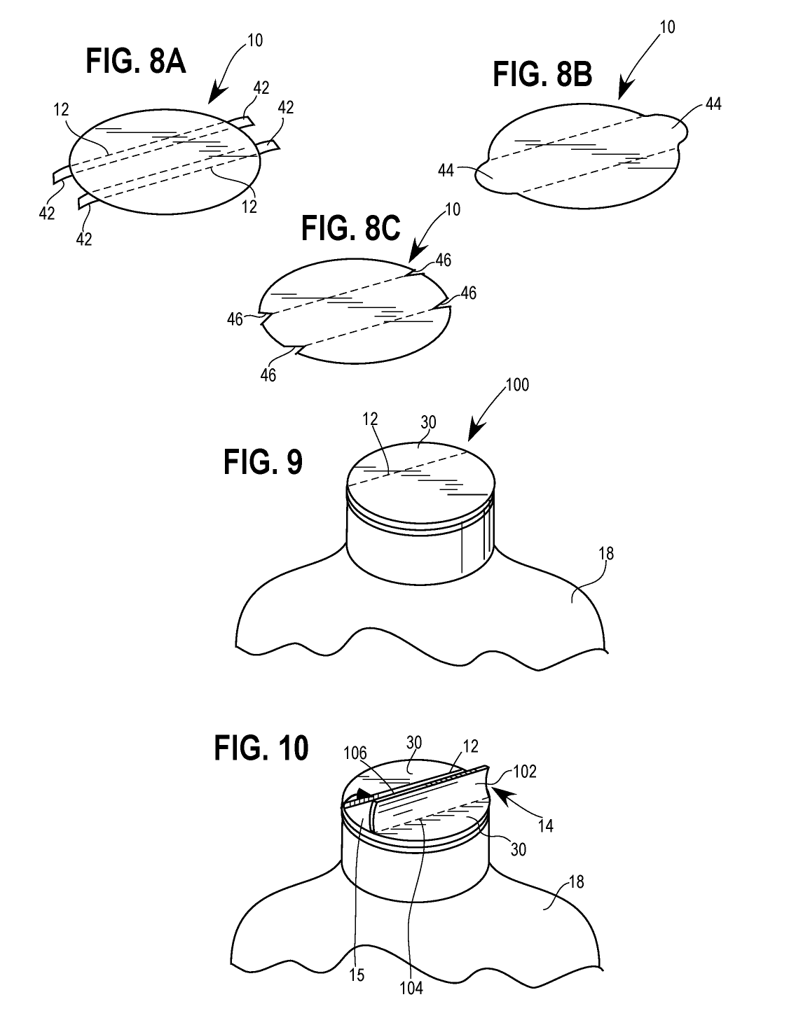

FIGS. 8A, B, and C illustrate optional components to aid in forming the tear along the frangible lines of weakness. FIG. 8A includes embedded narrow tear strips 42 that are positioned within the laminate along the lines of weakness 12. In use, the consumer grasps the exposed tag from the tear strip 42 and peels them back. The peeling of the tear strips 42 propagates tearing along the frangible line so weakness. FIG. 8B illustrates opposing peripheral flange tabs 44 that are aligned with the panel 14. The tabs would provide an easy grasping surface to remove the strips 14. In one approach, the tabs 44 may extend the entire width of the panel 14 between the lines of weakness 12. Lastly, in FIG. 8C, notches 46 are defined along a perimeter of the sealing member 10 and aligned with the frangible lines of weakness 12.

As shown by the approach of FIGS. 3, 4, 6, and 7, the frangible lines of weakness 12 extend only partially through the laminate 16, and in some approaches, extend through the top layer 26 and the bonding layer 24, but do not extend through the other layers in the seal 10. This is advantageous because it enables the sealing member when applied to a container, to provide a hermetic seal because there are no gaps, openings, cuts, or other perforations extending through the sealing member (that is, there are no gaps, openings, cuts, or other perforations in layers 20, 22, and/or 23 in these approaches.) In some approaches, the frangible lines of weakness 12 may be a line of perforations or spaced cuts that extend through the desired layers. In other approaches, the lines 12 may be laser cut perforations or other deformities. In yet other approaches, the frangible lines of weakness may be narrow, elongate deformations fracturing seams, or thinner areas in the desired layers that permit ease of tearing or fracturing along the deformations. In yet other approaches, the lines of weakness may be a fracturing seam as generally described in Switzerland Patent Application No. CH 01268/13, which is incorporated herein by reference in its entirety. Exemplary films and one exemplary method of forming films with such fracturing seams are described more fully below.

FIGS. 9-13 generally illustrate a second approach of a sealing member 100 utilizing a single fracturing seam or frangible line of weakness 12 and configured to release a panel 14 that is not removed from the seal. In this approach, the released panel 14 forms a pull tab 102 upon fracturing or tearing along the single line of weakness 12. Sealing member 100 is similar to sealing member 10 previously described and may include similar laminate layers as generally shown in the figures with similar reference numbers. This approach also shows some views with optional layer 23, which is not needed in all applications. These layers will not be described again with this approach for brevity. As with the previous approach, the release layer 25 aids in forming the tab 102 because the release layer 25 is bonded to the layers above it, but not bonded to the layers below it.

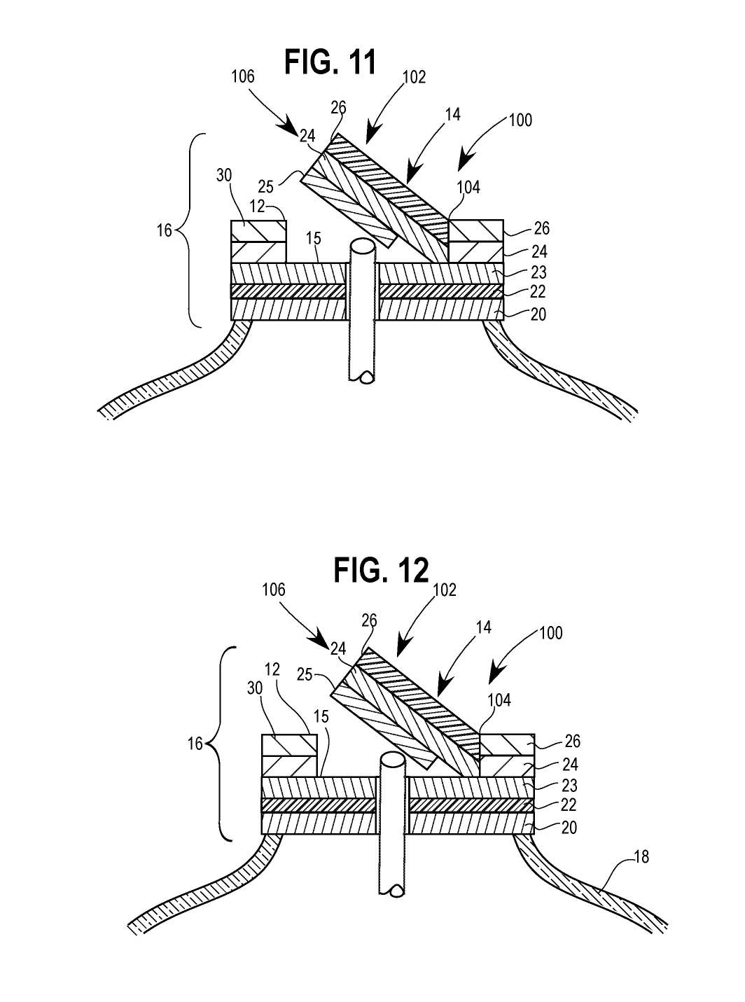

In this aspect of the disclosure, upon tearing along the single frangible line of weakness 12, a panel 14 is released and permitted to be pivoted upwardly along a pivot line 104 to form a pull tab 102 that is defined wholly within a perimeter of the sealing member 100 as generally shown in FIGS. 10, 11, and 12. In this approach, the panel 14 remains attached to the sealing member 100 opposite the line of weakness 12 along the pivot line 104 to form a living hinge. Tearing along the line 12 and then pivoting up the tab 102 along the hinge 104 exposes the portion 15 therebelow for piercing as described in the previous approach (such as in FIG. 12 that shows the tab 102 pivoted upwardly and the portion 15 pierced by a straw).

Alternatively, the tab 102 may be used for grasping, such as between the thumb and fore finger so that a consumer can use the tab to pull off the entire sealing member 100 (or certain portions thereof if needed for a particular application) from the container rim. As appreciated, this formed tab 102 is a non-side-protruding pull tab that is formed by the consumer, in use, after the container is sealed and covered with the cap. This construction of a pull tab is advantageous because the tab 102 is initially secured within the sealing member disk on all sides and, thus, is protected during the heat seal, assembly, handling, and cap screwing operations in view of the tab 102 being initially connected to the remainder of the seal along the non-fractured frangible line of weakness 12 on one side and by the living hinge/pivot line 104 on the other side. Thus, a grasping, free end 106 of the tab is protected from damage and wrinkling during heat sealing and assembly only to be released and/or formed by the consumer upon tearing along the line 12. This construction permits thinner tab materials in view of the tab securement and protection during assembly.

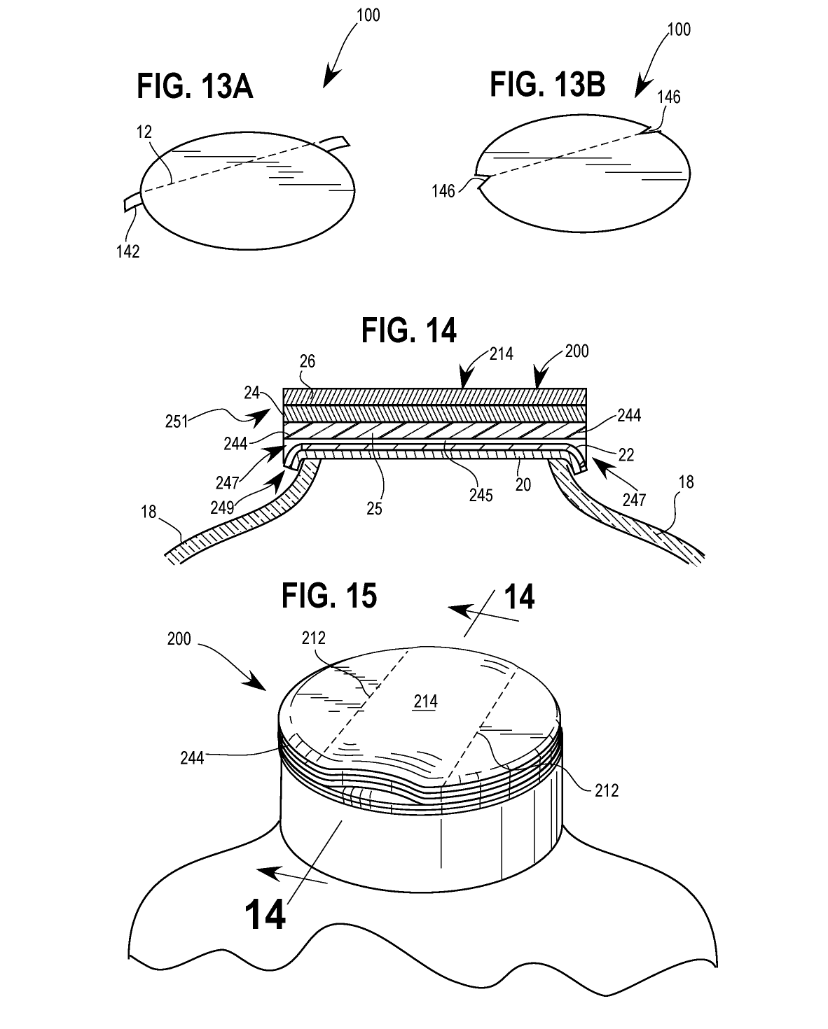

Similar to the previous approach, FIGS. 13A and 13B illustrate the use of a tear strip 142 within and aligned with the single frangible line of weakness 12 to aid in tear propagation in the approach of FIG. 13A. A small notch 146 may also be defined in the perimeter of the seal and aligned with the opposing ends of the single frangible line of weakness 12 as shown in the approach of FIG. 13B. Such features help start the tear, fracture, or peel along the line 12.

Turning now to FIGS. 14 and 15, one exemplary approach of the sealing members herein utilizing opposing side tabs will now be described further. In this alternative approach, a sealing member 200 is shown including opposing side tabs 244 that are associated with a releasable panel 214. The tabs 244 generally extend the entire width of the panel 214 between two frangible lines of weakness 212 as generally shown in the perspective view of FIG. 14. In this approach, the side tabs 244 include the layers above the release layer and the release layer itself; such as those layers previously described. The seal of this approach may include similar layers in a laminate as those previously described. As such, they will not be described further with respect to this approach.

As mentioned above, because the release layer 25 within the laminate is not secured or bonded to the layers below it, it may form a small air gap 245 under it and above the layers directly below. In view of the release layer forming this small air gap 245, the side tab 244 (such as top layer 26, bonding layer 24, and release layer 25) will tend not to fold or bend downwardly over any rim when secured to a container. The layers below the air gap, (such as heat seal layer 20 and foil layer 22) will tend to fold over the side of the container rim or neck due to the cap and heat sealing process during cap assembly. More specifically, the polymer films and resins used to form the layers 24, 25, and 26 tend to have molecular memory and be more resilient so that such layers when combined with the air gap will tend to remain relatively flat in the areas above the air gap because they are not bonded to the layers below. Thus, these layers will tend to stay relatively flat and extend outwardly over the container rim land area to form an outwardly extending tab as generally shown in FIG. 14. On the other hand, the foil layer 22, which is more deformable and less resilient, will tend not retain memory. In such circumstances, foil layer 22 and heat seal layer 20 will tend to be bent over and stay bent over the side of the bottle finish or rim side wall during the cap assembly process.

So constructed, a lower portion 249 of the tab including the heat seal layer 20 and foil layer 22 will be folded over the container rim and a second portion 251 of the tab including top layer 26, bonding layer 24, and release layer 25 remain relatively flat and protrude more outwardly for a consumer to grasp and peel off the removable tear strip 214. This difference in memory or resiliency of the upper and lower portions of the seal laminate 249 and 251 would cause a physically and visually recognized gap 247 resulting from the downwardly folded portion 249 and the outwardly flat portion 251 at a periphery of the seal. A consumer could then be instructed to recognize this gap 247 and use it to identify the flat tab portion 251 and, thus, the tear strip 214 for ease in releasing the desired panel 214.

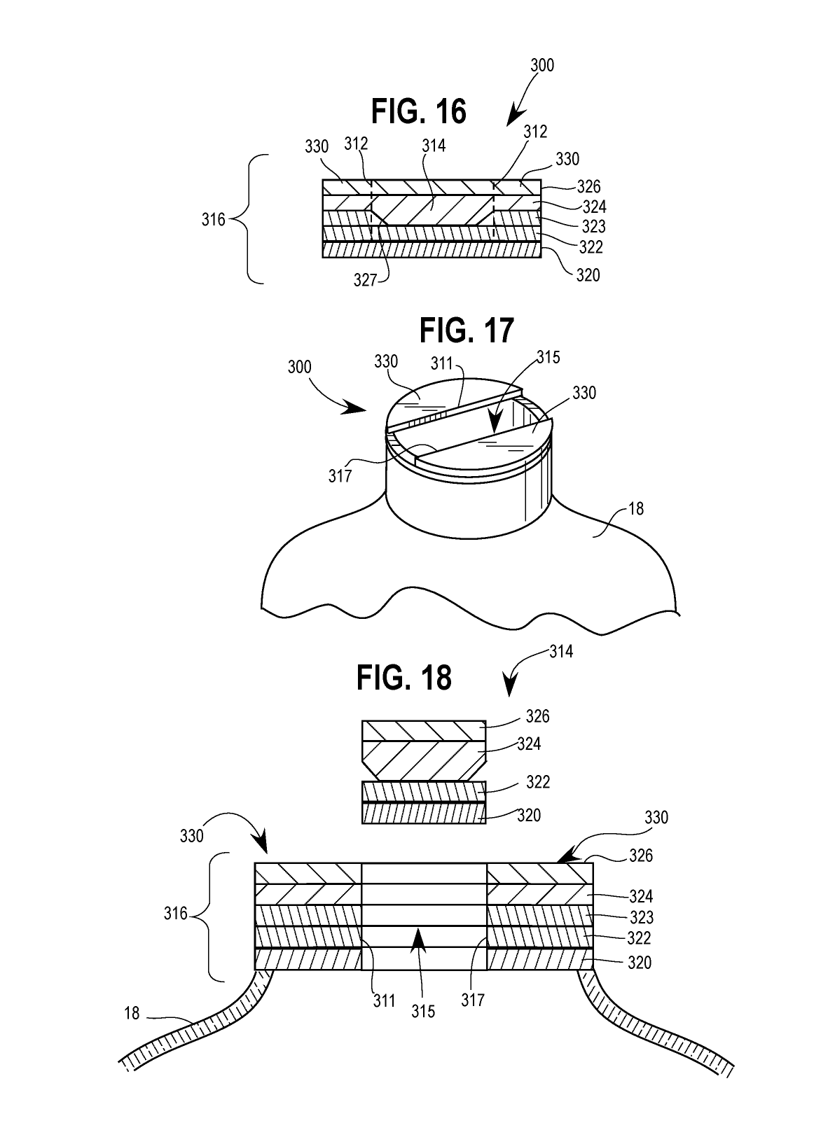

Turning now to FIGS. 16 to 18, another exemplary sealing member 300 is shown with a releasable and removable panel 314 between a pair of frangible lines of weakness 312. In this approach, the panel 314 is configured to release and remove an entire portion of the sealing member to form a through opening or orifice 315 into the container. Thus in this approach, the consumer will not need to pierce or puncture the seal to gain access, but releasing the panel 314 removes all portions of the seal associated with the panel 314 to gain access without piercing. As shown, the orifice 315 is rectangular, but other shapes may be possible depending on the configuration of the frangible lines of weakness 312. In this approach, opposing edges 311 and 317 of the orifice 315, which are generally flat, could be beneficial to a consumer if the package contents are intended to be spooned out in level measurements as the orifice side edges would present a flat scraping surface.

One approach of a structure to form the orifice 315 is generally shown in the cross-sectional views of FIGS. 16 and 17. Here, a laminate 316 may include a full-width, lower heat sealable layer 320, a full-width membrane or foil layer 323, and an orifice defining layer 324, which is a partial layer having a void or other cavity 327 defined therein with cavity side walls defining the size and shape of the to-be-defined orifice 315. Above the orifice defining layer 323 there may be a full-width bonding layer 324 that bonds a full-width top layer 326 to the orifice defining layer 323. In some approaches, the bonding layer 324 may flow into the cavity 327 of the orifice defining layer 323 and bond the top layer 326 to the foil or membrane layer 322 through the cavity.

In use, a consumer releases and removes the panel 314 between the two lines of weakness 312. This approach may include the narrow tear strips, side tabs, and/or notches as with the previous approaches to aid in initiating line tearing. In doing so, the panel 314 tears the foil layer 322 and the lower heat seal layer 320 at the edges forming the cavity 327 in order to form the orifice 315. In some instances, when the orifice defining layer 232 is a polymer foam layer, such as a polyolefin foam, it may be advantageous for the orifice defining layer 323 to be about 2 mils or less, which aids in forming a clean tear of the foil layer 322 and the heat seal layer 320 at the side walls of the cavity 327. In other approaches, the seal may not include the orifice defining layer, but may have the frangible lines of weakness extend through the entire seal. After panel or tear strip 314 removal, this approach of the sealing members forms the open orifice 315 in the container for pouring, scooping, or otherwise dispensing the contents of the container.

Now that the basic structures of various sealing member with frangible lines of weakness are set forth above, further details about some of the various layers and components of the sealing members are described in more detail.

The lower heat sealable layer 20 or 320 may be any suitable hot melt adhesives or sealants for sealing or adhering to a container rim by an induction seal or other heat seal operation. For instance, the heat sealable layer may be, but is not limited to, polyesters, polyolefins, ethylene vinyl acetate, ethylene-acrylic acid copolymers, surlyn, and other suitable materials. By one approach, the heat sealable layer may be a single layer or a multi-layer structure about 0.2 to about 3 mils thick.

The membrane layer 22 or 322 in the various constructions may be a metal layer, such as, for example, aluminum foil. In one aspect, the metal layer may be about 0.3 to about 2 mils thick. The membrane layer may also be foil, tin, metalized polymers, and the like, as well as combinations thereof. The membrane layer may be any layer configured to generate induction heat.

The top layer 26 or 326 is often a puncture resistant layer or other polymer support layer and can be selected from a variety of suitable plastic materials to provide strength, support, and puncture resistance. For example, the plastic materials or film for top layer can be selected from the group consisting of polyester, preferably polyethylene terephthalate, polyamide, high density polyolefin, high density polypropylene, high density polyethylene or combinations thereof. In some approaches, the thickness of the top layer may be from about 0.5 to about 10 microns. For instance, the top layer 14 may be PET and have a thickness of about 0.5 to about 3 microns. The top layer imparts resistance to piercing or puncturing when the tear strip or panel 14 and 314 is still attached because the puncture resistant film covers the entire top surface of the seals herein. Upon tearing and release and/or removal of the strip or panel 14, then a secondary portion of the seal in the area 15 is exposed, which can have different, lower puncture properties to permit ease of piercing with a finger or other blunt object such as a straw. In some approaches, the laminate of seal portion 15 may include the foil layer 22 and the heat seal layer 20 or other easy to pierce layers such as polyolefins and the like. So constructed, the seals herein provide a dual functionality of a puncture resistant seal for initial handling and assembly, but afford a portion of the laminate to be exposed to permit ease in piercing or puncturing by a consumer in use.

The bonding layer 24 or 324 may include any polymer materials that are heat activated or heated when applied to achieve its bonding characteristics. By one approach, the heat-activated bonding layer may have a density of about 0.9 to about 1.0 g/cc and a peak melting point of about 145° F. to about 155° F. A melt index of the bonding layer 24 or 324 may be about 20 to about 30 g/10 min (ASTM D1238). Suitable examples may include ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials. By one approach, the bonding layer may be about 0.5 to about 2.0 mils thick and, in other approaches, about 0.5 to about 1.5 mils thick, in yet other approaches, about 0.5 to about 1.0 mils thick; however, the thickness can vary as needed for a particular application to achieve the desired bonds and internal strength.

By one approach, the bonding layer is EVA. In general, EVA is effective for the bonding layer because of its thermal bonding characteristics, such that it readily bonds to other layers in the laminate and forms a bond thereto greater than the internal rupture strengths of the various layers. By one approach, the bonding layer may have a vinyl acetate content of about 20 to about 28 percent with the remaining monomer being ethylene in order to achieve the bond strengths. A vinyl acetate content lower than 20 percent is generally insufficient to form the robust structures described herein.

As mentioned briefly above, the seals can also include additional layers as needed for a particular application. In some approaches, the seals may also include a separate layer 23 above the membrane layer 22. This separate layer may be a polymer foam layer (such as a polyolefin or polyester foam), a non-foam heat distributing polyolefin film layer, or other polymer support layers.

By one approach, an exemplary non-foam heat distributing polyolefin film layer is a blend of polyolefin materials, such as a blend of one or more high density polyolefin components combined with one or more lower density polyolefin components. Suitable polymers include but are not limited to, polyethylene, polypropylene, ethylene-propylene copolymers, blends thereof as well as copolymers or blends with higher alpha-olefins. By one approach, a suitable non-foam heat distributing polyolefin film layer is a blend of about 50 to about 70 percent of one or more high density polyolefin materials with the remainder being one or more lower density polyolefin materials. The blend is selected to achieve effective densities to provide both heat sealing to the container as well as separation of the liner from the seal.

By one approach, effective densities of the non-foam heat distributing polyolefin layer to achieve effective heat distribution within the seal when this layer is a non-foam may be between about 0.96 g/cc to about 0.99 g/cc. Above or below this density range in a non-foamed layer, unacceptable results are obtained because the layer provides too much insulation or does not effectively distribute heat. By another approach, the non-foam heat distributing layer is a blend of about 50 to about 70 percent high density polyethylene combined with low to medium density polyethylene effective to achieve the density ranges described above.

The layers in the various constructions may be adhered to each other directly or by an intervening adhesive or tie layer that is generally not shown in any of the figures. The adhesives useful for any such optional intervening adhesive layers or tie layers include, for example, ethylene vinyl acetate (EVA), polyolefins, 2-component polyurethane, ethylene acrylic acid copolymers, curable two part urethane adhesives, epoxy adhesives, ethylene methacrylate copolymers and the like bonding materials. Other suitable intervening layer adhesives may include low density polyethylene, ethylene-acrylic acid copolymers and ethylene methacrylate copolymers. By one approach, any optional adhesive layers may be a coated polyolefin adhesive layer.

In one approach, a fracturing seam or groove forming the frangible line(s) of weakness discussed herein may be formed in a foil or film, or a laminate thereof, in an easy and reliable manner utilizing a pair of rolls where at least one roll includes a protruding rib or ridge to form an seam, groove, indentation, or elongate cavity in the film. This formed fracturing seam or frangible line of weakness may be free of any punched-through portions or perforations. The fracturing seam may be used in the sealing members herein or on packaging films. Other methods of forming the frangible lines of weakness may also be used depending on the particular application.

In one aspect, the at least one fracturing seam may be formed on films, foils, or laminates thereof by passing the material between at least one pair of rolls, wherein the rolls are arranged in a parallel, spaced-apart configuration from each other in, and wherein at least one of the rolls includes at least one rib or ridge projecting outwardly from a peripheral surface of the roll. During rotation of the rolls, the rib enters into a region or nip located between both rolls, and with the film being passed into the nip between the rolls, the rib is pressed into the surface of the film. In doing so, a groove or indented line is formed in the surface of the film in the location where the rib engages the film. As a result, the tear-resistance of film is reduced in this location as compared to the remainder of the film in view of the thickness of the film being reduced due to the formed groove. Therefore, the groove forms a fracturing seam or frangible line of weakness, along which the film can be more easily tore-open along the groove or line in a controlled manner. In the case of a film machined in this way and used as a package for goods, the package can be easily opened by controlled fracturing or tearing along the formed seam. In some approaches, the groove can be formed by deforming or engraving the film. In the case of the rolls used on the laminates herein, the fracturing seam or frangible line of weakness allows controlled release of the panel 14 or controlled release and removal of the panel by fracturing or tearing along the fracturing seam or frangible line of weakness 12.

In one approach of a method forming the seam, a distance between the pair of rolls is adjusted according to the thickness of the film. Therefore, the film fits in-between the gap created by the space between both rolls, exactly, or may be compressed slightly, if necessary. In some approaches, the distance is set such that the film is being compressed slightly in areas not corresponding to the rib. In these areas, the film will tend to un-compress to its original thickness after the passage through the pair of rolls. In the portions of the film including the formed seam or groove, the rib is being pressed into the surface of the film in a manner and distance to exceed the film's limit of flexibility (but not to penetrate all the way through the film) so that a permanent deformation assuming the shape of a groove formed in the film. This results in a reduced thickness of the film in the location contacted by the rib. A shape and depth of the rib can be adjusted or set such that, based on the material, composition and thickness of the film, a desired permanent deformation will be formed into the film forming the fracturing seam or frangible line of weakness. In doing so, seams or grooves having a constant depth, having a reliable precision, and having a regular cross-section can be formed even in thin films or laminates in the range of about 20 μm or less.

In a further approach of said methods, the pair of rolls may be driven by one or move drive motors and, in particular, driven in a counter-rotating fashion. This means the top roll of a pair is driven clockwise and the bottom roll in the pair is driven counterclockwise, for example, in order to cause a movement in a down web or running direction of the film into the nip or gap between the rolls. Therefore, a pre-defined and controllable flow of the film can be achieved between the rolls. Further, seams or grooves can be achieved that are formed very precisely due to the rolls being free, in some approaches, of any relative velocity in relation to each other and the film passing through the nip. That is, the rib is pressed into the surface of the film in a precise manner and in a direction, in some approaches, extending substantially perpendicular to the surface of the film.

In a further approach, a plurality of roll pairs may be used in a configuration where the pairs are arranged next to each other, with each pair extending along one axis, and/or arranged spaced along the down web direction of the film in succession. In doing so, the film can include more than one fracturing seam positioned in different portions of the film, which provide a film, package, or seal laminate having fracturing seams being arranged differently or to re-shape the films so that it may include a plurality of different packaging designs simultaneously. The rolls itself can be embodied to comprise very small widths, improving the precision of the distance between pairs of rolls, and wherein very small nip widths can be set highly reliable. The rolls can be held and supported on both ends of the axis of rotation incorporating a high running precision. Therefore, wide film widths can be processed with high precision as well.

In yet a further approach, the film is moved or driven via separate, transportation pairs of rolls driven in a synchronized manner with the pair of rolls containing the rib. Therefore, the film can be moved or driven by a separate, specific set of driving rolls having surfaces optimized for transportation of the film, for example, soft and elastic surfaces. Therefore, the transportation rolls having a small diameter can be used for driving, for example, and the rolls provided with the rib may have a larger diameter for forming the seams or grooves. In view of the synchronization between the rotations of the rolls in relation to the different diameters, creation of a tangential relative movement between the surface of said film and the surface of said rolls is prohibited or minimized; otherwise, such relative movement can be set to a desired amount if desired.

An apparatus for forming the fracturing seams or frangible lines of weakness includes at least a pair of rolls being spaced apart from each other in parallel arrangement with at least one of the rolls including at least one rib or ridge projecting outwardly from a surface of the roll. During rotation, the rib is pressed into a surface of the film or laminate being passed between the rolls, and in doing so, a permanent seam or groove is formed. Such seam or groove creates the fracturing seam or frangible line of weakness suitable for the sealing members herein and packaging films as needed for particular applications.

In one approach, the rib has radial extension or height, as compared to the height of the gap between the pair of rolls, that is smaller than the gap. Therefore, the rib does not cut through the film or otherwise perforate all the way through the film. In some forms, the rib has straight sides with a rectangular or trapezoid cross-section and rectangular or chamfered corners on outer edges thereof. Therefore, an optimal groove can be formed corresponding to the material of the film, wherein the groove or seam can be easily fractured or tore-open in a controlled manner along the groove or seam, but at the same time still maintains the integrity of the film because the groove does not penetrate all the way through the film. In this manner, the film can be used as a sealing member or packaging because there are no penetrations or other gaps in the film to permit air and moisture to pass through.

In other approaches, a plurality of ribs may be arranged on the surface of the roll in a spaced apart relationship and/or in parallel configurations. In doing so, a plurality of grooves or seams can be formed on the film in succession or in cooperation with each other to be arranged parallel to each other on the film. For example, this is advantageous when the film is to be separated in a plurality of sheets, originally arranged side by side, in a proceeding stage, in order to produce individual packages or sheets of materials for seal laminates. As an alternative, rolls can be used having a large diameter and with the ribs arranged close to each other for use on small or slim packages.

In yet a further approach, the rib is arranged along the longitudinal axis of the roll, or, alternatively, arranged transverse to the longitudinal axis of the roll transverse. According to the arrangement of the ribs, seams or grooves extending longitudinal or transvers in relation to the direction of movement of the film can be formed. Alternatively, the rib can be formed to be straight or curved, and can be further arranged diagonally in relation to the longitudinal axis of the roll.

The outer profile of the rib may be formed with straight outer edge and have a constant radial distance from the longitudinal axis of the roll, which may be continuously or interrupted across the longitudinal surface of the rib. In case of the outer edge of the rib being formed in a straight and continuous profile across the roll with a constant radial distance from the longitudinal axis of the roll (i.e., assuming a constant and continuous height of the rib), then a fracturing seam may be formed having a continuous depth and cross-section. Alternatively, the profile of the rib can be contoured in relation to its height, wherein it can be formed as stepped, angled, serrated, and the like. In this manner, a fracturing seam or groove having a correspondingly formed contour would be formed. This approach would still provide optimal tearing-open characteristics to the film in relation to the configuration and thickness of the material, in addition to providing appropriately large resistance against unintended fracturing required for storage and transportation. Further, it is conceivable that the rib itself may be formed to extend not in a straight manner but rather to include a curvature or any other regular or irregular extension thereof from the surface of the roll. For example, for a package intended for tearing-open of only a corner part of the package, the film may include a curved fracturing seam, which can be accomplished via a pattern of fracture seams including a curved or even rounded opening rather than a straight opening.

In a further embodiment, both rolls of said pair of rolls may include one or more ribs projecting outwardly. In such approach, the ribs can be arranged on both rolls of the pair of rolls, in order to form seams, recesses, or grooves on both surfaces of the film. Assuming a corresponding synchronization of both rolls, formation of a fracturing seam is conceivable that is formed on both sides of the foil at the same time.

More specifically, FIG. 19 is a schematic view of an article 2, which is packed by a package 1, formed by an airtight film. The package 1, in some approaches, may be formed by welding two layers of film 3, for example, where welding seams 4 extend along the side edges of said package 1. The welding seam 4 can be provided with an indentation 4′, for example, in order to facilitate tearing-open in this location.

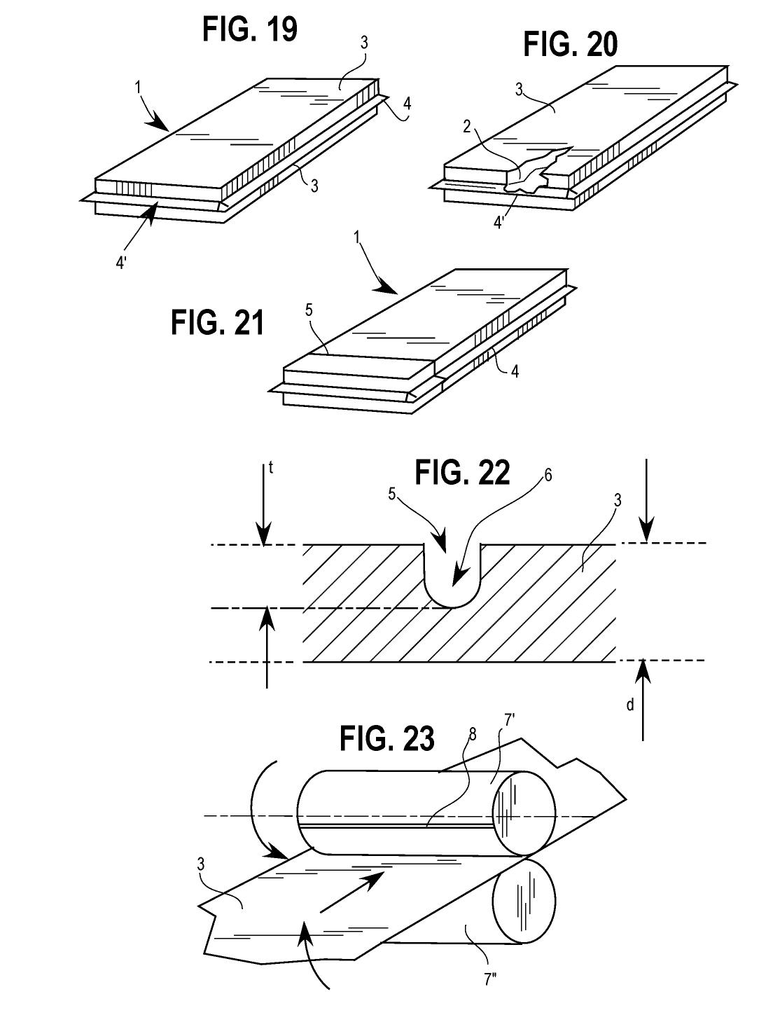

FIG. 20 shows the package 1 of FIG. 19 after tearing-open by hand starting from the indentation 4′. With such approach, an uncontrolled fracture pattern will tend to result having an arbitrary characteristic and tear. Often, with such approach, the package will be opened more or less completely.

FIG. 21 shows a further package including the fracturing seam 5 of the present disclosure arranged to extend transversely about the package. In use, pulling the package in the region of said fracturing seam 5 results in formation of a defined fracture pattern along the fracturing seam 5, which results in the package being opened corresponding to the formation of the fracturing seam 5.

FIG. 22 is a cross sectional view across the film 3 showing the vicinity of the fracturing seam 5. Here, the fracturing seam 5 is formed by means of a seam or groove 6 in the surface of the film 3 and includes rectangular or slightly rounded cross-section or profile having a groove depth “t.” However, the groove depth “t” is less than the thickness “d” of the film 3. In some approaches, for example the groove depth “t” may be 0.6>t<0.3 relative to the thickness of the film. Conventionally, the groove 6 may be formed by a laser beam, for example, directed across the surface of the film 3. In doing so, the amplitude of the laser beam may need to be adjusted to result in a groove 6 having the particular, limited depth “t,” and to prevent penetrating through the film, which would affect the sealing capability of the film to form a package or the sealing members herein.

FIG. 23 is an example of a pair of rolls 7 including a top roll 7′ and a bottom roll 7″. Between the pair of rolls 7, the film 3 is being passed into a gap or nip formed therebetween, which forms the groove or seam 6 upon the rotation of the rolls 7. In the approach illustrated, the top roll 7′ is provided with a rib or ridge 8, which is a rib extending across the whole width and in parallel to the rotating axis of the top roll 7′. The rib 8 projects radially outwardly from the skin surface of the top roll 7′, and engages with the surface of the film 3 when it rotates to the gap between both rolls 7′ and 7″ following each rotation of the rolls 7′ and 7″, respectively.

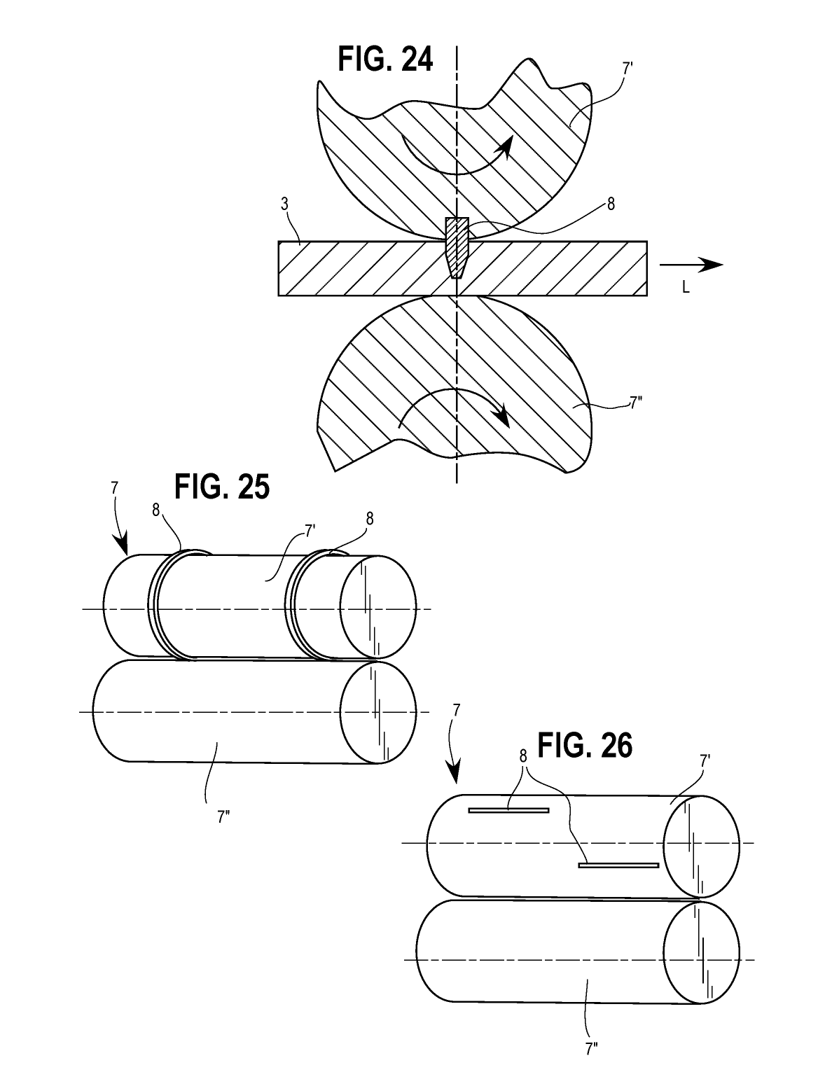

FIG. 24 is a cross-sectional view across the pair of rolls 7 from FIG. 23 showing the rib 8 being positioned straightly into its deepest point of the film during engagement with the film 3 within the nip between the rolls 7. The advantage of this arrangement is that a straight groove 6 is formed extending continuously across the width of the film and transvers to the running direction “L” or down web direction of the film 3 during continuously feeding of the film 3. Since the geometrical relationships of the groove 6 are defined and fixed due to the outer profile (shape and dimension) of the rib 8 as well as the distance between rolls 7′ and 7″ (even in the case of high running velocities of the film), consistent and precise grooves 6 can be formed having constant and regular cross sectional profiles in the film. Such consistent seams may even be formed in very thin films.

While FIG. 24 shows the rib 8 formed of a separate component inserted into the roll 7′. A person skilled in the art will appreciate that the rib 8 can be formed in or out of the skin surface of the roll 7′ directly as needed for a particular application. In the case of very thin films 3, ribs having a height in the range of, but not limited, to about 10 μm to about 20 μm may be used, which can be produced by machining the surface of the desired roll 7. It will be appreciated that the scale depicted in FIG. 24 is not intended to represent actual scales. In an alternative approach, the rib 8 can also be formed to assume a shaper cutting rib having a cutting edge, such as a tapered side walls to form a cutter or sharp outer edge.

By using this approach, a single layered film (or laminate) having a thickness of, but not limited, to about 25 μm to about 50 μm, for example, can be provided with a groove or seam 6 having a depths of approximately 15 μm, while avoiding or minimizing the risk of the groove 6 penetrating entirely through the film forming an through opening or other open fracture in the film. Additionally, high running velocities can be set without reductions in the quality, which benefits effective production. Afterwards, the machined film 3 can be used for producing a air-tight package 1 already applied with a fracturing seam 5, wherein the fracturing seam 5 exhibits a defined resistance against fracture. The machined film 3 may also be used within the sealing members or laminate sheets to form the sealing members described herein to form the layers with the frangible lines of weakness.

The method or rather apparatus can also be used to machine multi-layered films 3, wherein the groove depths “t” can be adjusted easily and reliably to the thickness of the topmost layer or other layers as needed of the film laminate 3. Therefore, grooves 6 can be formed reliably, for example, solely into the top layers of multi-layered laminate 3, if necessary, or may extend into one or more layers of the laminate.

FIGS. 25 to 27 illustrate pairs of rolls 7 incorporating different arrangements of the ribs 8. For instance, FIG. 25 depicts an arrangement of ribs 8 arranged to surround the periphery of the roll 7′ generally transverse to the roll axis. In this case, the ribs 8 form two grooves 6 arranged parallel to each other in the down web length direction of the film. Such configuration may be used to form the sealing members described earlier in this disclosure. FIG. 26 depicts an arrangement with a plurality of ribs 8 arranged parallel to the rotating axis of the roll 7′ and being arranged in a staggered relation to each other about the surface of the roll 7′. In this configuration, each rib 8 extend across a part width of the roll 7′.

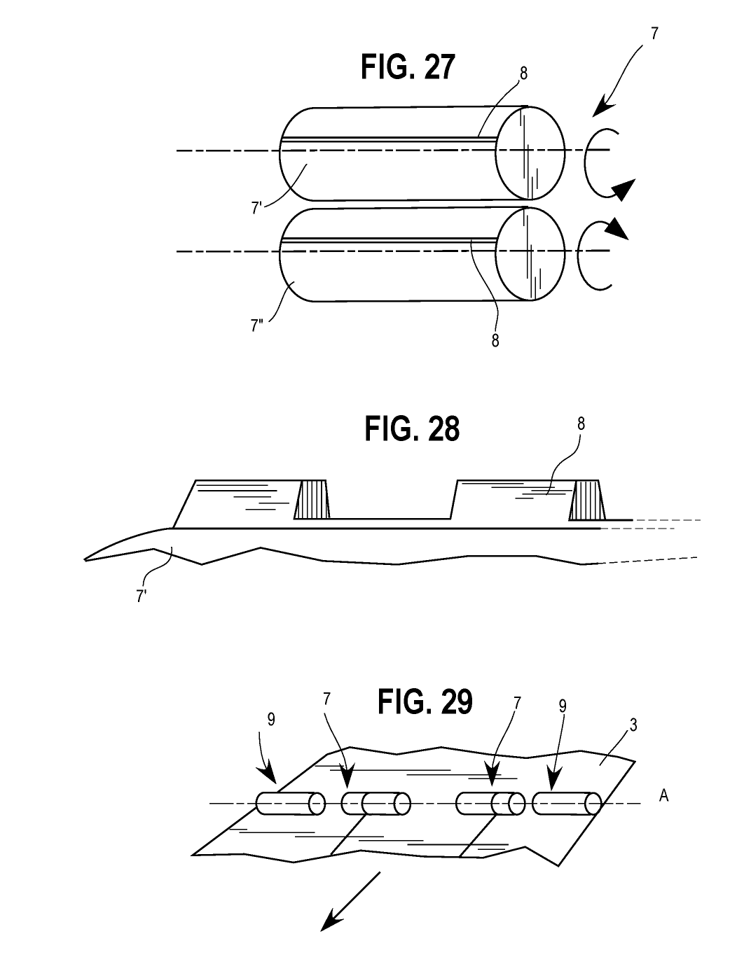

FIG. 27 depicts an arrangement of ribs 8 on both rolls 7′ and 7″. In this approach, the ribs 8 are arranged in parallel to the rotating axis of rolls 7′ and 7″. In usage, grooves or seams 6 can be formed extending transverse in relation to the down web direction of the film (not shown), which are, for example, formed alternatingly on the top surface or bottom surface of the film 3. Having regard to this arrangement, it is conceivable to synchronize rotations of both rolls 7′ and 7″ such that both ribs 8 each synchronously will engage into the surface of the film 3 from above and from below simultaneously resulting in a fracturing seam 5 with a groove 6 arranged on both sides of the film. In doing so, added heights of both ribs are less than the gap created between the rolls 7′ and 7″ in order to prevent formation of a through opening or other cut in the film instead of the fracturing seams herein.

Alternatively, the ribs 8 can have different shapes, profiles, lengths, and sizes in order to create fracturing seams 5 being curved, bent, or shaped otherwise, rather than fracturing seams 5 extending straight, transversely, or longitudinally to the film.

In yet another approach, FIG. 28 illustrates an embodiment of the rib 8 having a corrugated or stepped outer profile or edge. Thus, a fracturing seam 5 is formed having a groove 6 with an alternating depth rather than a constant depth.

Finally, FIG. 29 shows an approach of an arrangement including a plurality of pairs of rolls 7 as well as additional transport or driving rolls 9. The pairs of rolls 7 and the driving rolls 9 can be arranged to extend along a common axis A or can be arranged staggered in relation to each other. In such arrangement, the driving rolls 9 are used to transport the film 3, and the pairs of rolls 7 are solely used to form the fracturing seam 5 or groove 6. However, as a matter of course, one pair of rolls 7 can be used to transport the foil-run 3 as well as to form the fracturing seam 5 at the same time.

In use, the sealing member described and shown herein can be cut into appropriately sized disks from sheets of material to form a vessel closing assembly such as generally shown by the die cut lines 40a and 40b in FIG. 5, for example. The cut sealing member is then inserted into a screw cap or other closure which, in turn, is applied to the neck of a container to be sealed. The screw cap can be screwed on to the open neck of the container, thus sandwiching the sealing member between the open neck of the container and the top of the cap. Heat is then applied to seal the bottom subassembly of layers forming the seal portion to the neck of the container. Upon a consumer removing the cap, the sealing member remains adhered to the container rim for the consumer to then release the defined tear strip of panels as set forth herein.

It will be understood that various changes in the details, materials, and arrangements of the seal members, which have been herein described and illustrated in order to explain the nature of the seals described herein, may be made by those skilled in the art within the principle and scope of the embodied description.

1. A sealing member for a container having an opening surrounded by a rim, the sealing member comprising:
a seal laminate having at least a top layer and a heat sealable layer on a lower surface thereof, the heat sealable layer effective to secure the seal laminate to a container rim during heat sealing;
a portion of the top layer directly or indirectly bonded to the heat sealable layer and another portion of the top layer not bonded to the heat sealable layer;
a frangible line of weakness associated with the unbonded top layer portion and extending from one edge of the seal laminate to an opposite edge of the seal laminate; and
the frangible line of weakness configured to tear therealong for releasing a panel of the unbonded top layer portion from the bonded top layer portion.

2. The sealing member of claim 1, wherein the unbonded top layer portion includes a second frangible line of weakness associated therewith and configured to tear therealong so that tearing both the frangible line of weakness and the second frangible line of weakness releases and separates the panel from the sealing member.

3. The sealing member of claim 1, further comprising a bonding layer between the top layer and the heat sealable layer and a partial strip of material associated with the unbonded portion of the top layer, the partial strip of material secured to the bonding layer but not secured to the heat sealable layer.

4. The sealing member of claim 1, wherein the frangible line of weakness and/or the second frangible line of weakness is adjacent to the partial strip of material.

5. The sealing member of claim 1, wherein the released panel pivots upwardly at a pivot line to form a gripping tab.

6. The sealing member of claim 5, further comprising a bonding layer between the top layer and the heat sealable layer and a partial strip of material associated with the unbonded portion of the top layer, the partial strip of material secured to the bonding layer but not secured to the heat sealable layer.

7. The sealing member of claim 1, further comprising tabs extending outwardly from a perimeter of the sealing member and associated with the frangible line of weakness.

8. The sealing member of claim 1, wherein release of the panel exposes one or more layers below the panel.

9. The sealing member of claim 8, wherein the exposed one or more layers under the panel are more easily pierced than the top layers.

10. The sealing member of claim 1, wherein the bonded portion of the top layer is on opposing sides of the unbonded top layer portion.

11. The sealing member of claim 1, wherein an air gap is formed under the unbonded portion of the top layer.

12. A method for forming at least one fracturing seam on a film, the method comprising passing the film between at least one pair of rolls, wherein said rolls are arranged spaced apart from each other in parallel, wherein at least one of said rolls comprises at least one rib projecting from the surface of the roll.

13. The method according to claim 12, wherein the distance between said pair of rolls corresponds to the thickness of the film or less.

14. The method according to claim 12, wherein the rolls are driven by a drive, in particular driven in counter-rotation direction.

15. The method according to claim 12, using a plurality of pairs of rolls.

16. The method according to claim 12, wherein said film is moved or driven by means of pairs of transport rolls, which are driven synchronously in relation to the pair of rolls.

17. An apparatus for performing the method according to claim 12, comprising at least one pair of rolls arranged spaced apart from each other in parallel, wherein at least one of said rolls comprises at least one rib projecting from the surface of the roll.

18. The apparatus according to claim 17, wherein the rib comprises a radial extension being less than the height of the gap formed between both rolls.

19. The apparatus according to claim 17, wherein the rib is formed to assume a straight rib having a rectangular or trapezoid cross-section and rectangular or rounded corners.

20. The apparatus according to claim 17, wherein a plurality of ribs are arranged onto the surface of the one roll spaced apart from each other in parallel.

21. The apparatus according to claim 17, wherein the rib is arranged in one of parallel to the longitudinal axis of the roll or is arranged transversely to the longitudinal axis of the roll.

22. The apparatus according to claim 17, wherein the outer corner of the rib is formed to be straight, continuously, having a constant radial distance from the longitudinal axis of the roll.

23. The apparatus according to claim 17, wherein both rolls of the pair of rolls comprise ribs projecting radially.
